(19) United States
(12) Patent Application Publication
(10) Pub. No.: US 2021/0155257 A1
(43) Pub. Date: May 27, 2021

(54) SYSTEMS AND METHODS OF GEOMETRIC VEHICLE COLLISION EVALUATION

(71) Applicant: Continental Automotive Systems Inc., Auburn Hills, MI (US)

(72) Inventors: Javier Adolfo Alcazar Olan, Blacksburg, VA (US); Eduardo Jose Ramirez Llanos, Rochester, MI (US)

(21) Appl. No.: 16/692,322

(22) Filed: Nov. 22, 2019

(51) Int. Cl. B60W 50/14; B60Q 9/00; B60W 30/09

(52) U.S. Cl. CPC B60W 50/14; B60Q 9/00; B60W 2050/0031; B60W 2420/42; B60W 2420/52; B60W 30/09

(57) ABSTRACT

A method for evaluating a collision condition for a vehicle includes providing a first polygon representative of the vehicle, determining the existence of an object near the vehicle, providing a second polygon representative of the object, calculating the Minkowski Difference between the first polygon and the second polygon to create a convex hull, determining the minimum distance between the convex hull and an origin of a coordinate system in which the first polygon and the second polygon are overlayed, determining whether there is a collision condition based on whether the minimum distance is below a threshold value, and initiating a vehicle response if a collision condition is detected.

### BACKGROUND

This disclosure relates generally to systems and methods for vehicle collision evaluation using geometric principles.

Automotive vehicles are being equipped with collision avoidance and warning systems for predicting a potential collision with an object, such as another vehicle or pedestrian in some examples.

### SUMMARY

A method for evaluating a collision condition for a vehicle, according to an example of this disclosure, includes providing a first polygon representative of the vehicle, determining the existence of an object near the vehicle, providing a second polygon representative of the object, calculating the Minkowski Difference between the first polygon and the second polygon to create a convex hull, determining the minimum distance between the convex hull and an origin of a coordinate system in which the first polygon and the second polygon are overlayed, determining whether there is a collision condition based on whether the minimum distance is below a threshold value, and initiating a vehicle response if a collision condition is detected.

In a further example of the foregoing, the first polygon is a rectangle.

In a further example of any of the foregoing, the object is a second vehicle near the vehicle.

In a further example of any of the foregoing, the determining step includes sensing the object with a sensor on the vehicle.

In a further example of any of the foregoing, the sensor is a camera.

In a further example of any of the foregoing, the sensor is a radar sensor.

In a further example of any of the foregoing, the first polygon and the second polygon are convex polygons.

In a further example of any of the foregoing, the method includes determining whether there is a collision condition based on whether the slope of a plot of the Minkowski Difference value against time is below a threshold value.

In a further example of any of the foregoing, the vehicle response is to alert a driver of the vehicle.

In a further example of any of the foregoing, the vehicle response is to activate a braking system of the vehicle.

A system for evaluating a collision condition for a vehicle according to an example of this disclosure includes a sensor for sensing the existence of an object near the vehicle. A controller is configured to calculate the Minkowski Difference between a first polygon representative of the vehicle and a second polygon representative of the object to create a convex hull, to determine whether there is a collision condition based on whether the minimum distance from an origin of a coordinate system in which the first polygon and the second polygon are overlayed to the convex hull is below a threshold value, and to initiate a response if a collision condition is determined.

In a further example of the foregoing, the sensor is a camera.

In a further example of any of the foregoing, the sensor is a radar sensor.

In a further example of any of the foregoing, the first polygon is a rectangle.

In a further example of any of the foregoing, the object is a second vehicle near the vehicle.

In a further example of any of the foregoing, the first polygon and the second polygon are convex polygons.

In a further example of any of the foregoing, the controller is an electronic control unit on the vehicle.

These and other features may be best understood from the following specification and drawings, the following of which is a brief description.

### BRIEF DESCRIPTION OF THE DRAWINGS

FIG. 1 schematically illustrates a system 12 for evaluating a collision condition.

FIG. 2 schematically illustrates representative polygons.

FIG. 3A illustrates the example polygons of FIG. 2 overlayed onto a coordinate system.

FIG. 3B illustrates the second example polygon of FIG. 3 reflected around the origin.

FIG. 4 illustrates the convex hull of the Minkowski difference of the example polygons overlayed onto the coordinate system.

FIG. 5A illustrates the relative positions of the example polygons at a point in time.

FIG. 5B illustrates a plot of the distance between the convex hull of the Minkowski difference of the polygons and the origin at the point in time shown in FIG. 5A.

FIG. 6A illustrates the relative positions of the example polygons at a later point in time than in FIG. 5A.

FIG. 6B illustrates a plot of the distance between the convex hull of the Minkowski difference of the polygons and the origin at the point in time shown in FIG. 6A.

FIG. 7A illustrates the relative positions of the example polygons at a later point in time than in FIG. 6A.

FIG. 7B illustrates a plot of the distance between the convex hull of the Minkowski difference of the polygons and the origin at the point in time shown in FIG. 7A.

FIG. 8A illustrates the relative positions of the example polygons at a later point in time than in FIG. 7A.

FIG. 8B illustrates a plot of the distance between the convex hull of the Minkowski difference of the polygons and the origin at the point in time shown in FIG. 8A.

FIG. 9 illustrates a flowchart of a method for evaluating a collision condition for a vehicle.

### DETAILED DESCRIPTION

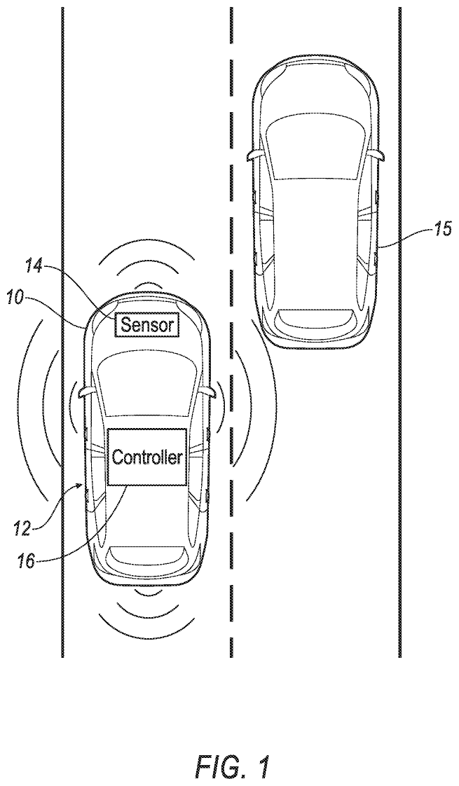

FIG. 1 schematically illustrates a vehicle 10 including a system 12 for evaluating a collision condition. In some examples, the collision condition is that a collision with the vehicle 10 has occurred. In some examples, the collision condition is that a collision with the vehicle 10 is imminent. The example system 12 may include, as shown, a sensor system 14 for sensing the existence of an object 15 near the vehicle 10. In some examples, the sensor system 14 is composed of any one or a combination of sensors from the following list: camera, radar, ultrasonic, Lidar, etc. Although one object 15 is shown in the illustrative example, the example sensor system 14 may be capable of sensing multiple objects at once. The example object 15 is a second vehicle on the road near the vehicle 10, but the systems and methods disclosed may be utilized with other objects, such as pedestrians, bicyclists, debris, signage, construction zone objects, or other objects. In some examples, the position of the object 15 may be communicated over the air to the vehicle 10 by way of Dedicated Short Range Communications (DSRC) from the object 15.

The example system 12 includes controller 16 for determining a collision condition. In some examples, the controller 16 is an electronic control unit (ECU) that may include one or more individual electronic control units that control one or more electronic systems or subsystems within the vehicle 10. As is explained herein, the controller 16 is programmed to calculate the Minkowski Difference value between a first polygon representative of the vehicle and a second polygon representative of the object and to determine whether there is a collision condition based on whether the distance from the origin to the convex hull of the Minkowski Difference value is below a threshold value. The controller 16, in some examples, may include one or more computing devices, each having one or more of a computer processor, memory, storage means, network device and input and/or output devices and/or interfaces.

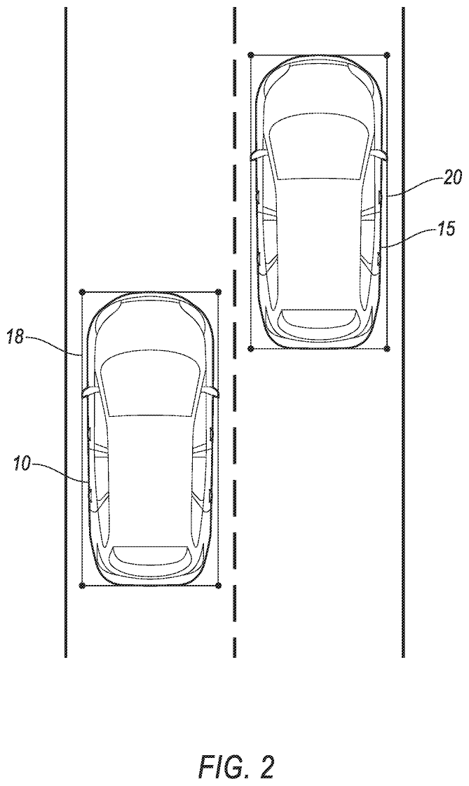

As illustrated schematically in FIG. 2, a first polygon 18 is provided that is representative of the vehicle 10. A second polygon 20 is provided that is representative of the object 15. In the illustrative example, the polygons 18, 20 form rectangles, but other polygons may be utilized in some examples. In some examples, the polygons 18, 20 have between 3 and 8 vertices. In some examples, this range allows for accurate readings that are also computationally efficient. In some examples, the polygon 18 is a convex polygon such that the vehicle 10 is contained within the polygon 18. The polygon 20 may also be a convex polygon in some examples. As shown, the example polygons 18, 20 enclose their respective vehicles 10, 15. In the illustrative example, the polygons 18, 20 are overlayed onto an overhead plane of the vehicle 10.

The polygons 18, 20 are then overlayed onto a coordinate system and assigned coordinates, which may be done with an arbitrary origin. The Minkowski difference between the polygons may then be calculated to determine a convex hull. The convex hull of a set of points is defined as the smallest convex polygon, that encloses all of the points in the set. A convex polygon has no corner that is bent inwards. The distance from the origin to the convex hull may then be computed to determine the distance between the two polygons 18, 20, which is representative of the distance between the vehicle 10 and the object 15.

As the illustrative examples herein demonstrate, the Minkowski difference of two polygons is a polygon with the sum of all elements from the first polygon (A) and all elements of the reflection of the second polygon (B) around the origin:

AθB={a−b:a ∈ A, b ∈ B}

In other words, the Minkowski difference AθB is computed performing the Minkowski sum of the first polygon (A) with polygon (−B)

AθB=A ⊕ (−B)

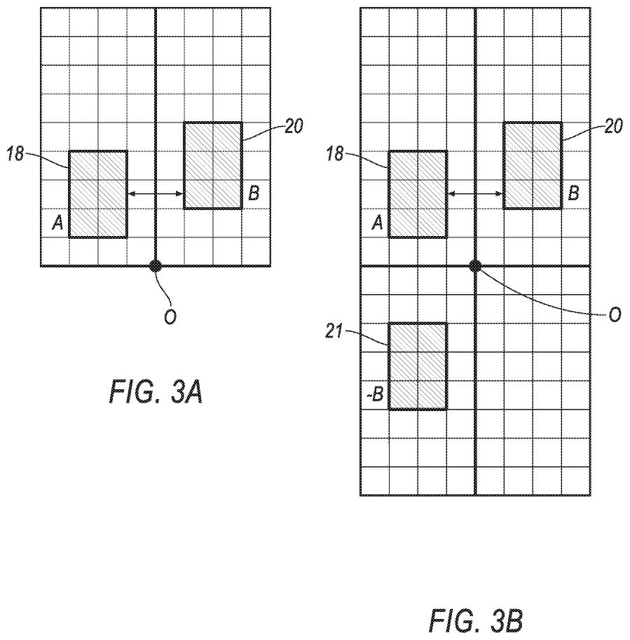

FIG. 3A illustrates the example polygons 18, 20 overlayed onto a coordinate system. The Minkowski difference between the polygons may then be calculated to determine the convex hull.

FIG. 3B illustrates the polygon 21, which is representative of the polygon 20 reflected around the origin O. The polygon 21 is the polygon (−B), and it is then used to create the convex hull of the Minkowski difference of the polygons 18, 20.

With reference to FIG. 2, the origin O is at a fixed point, such as a fixed point on the ground between the vehicles 10, 15. In some examples, the origin O may be fixed to the vehicle 10, such that the origin O travels with the vehicle 10. In some examples, the origin O is located at the center of the rear axle. In some examples, the origin is located at the geometric center of the polygon 18 representing the ego vehicle 10.

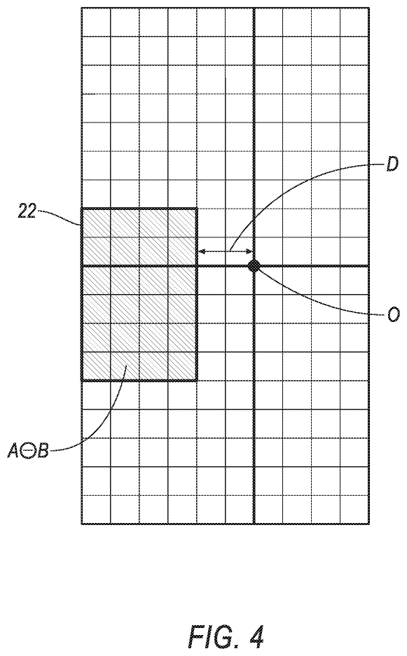

FIG. 4, with continued reference to FIG. 3, illustrates the convex hull 22 of the Minkowski difference of the example polygons 18, 20 overlayed onto the coordinate system. The minimum distance D between the convex hull 22 and the origin O is representative of the distance between the two polygons 18, 20, and therefore the minimum distance to collision between the vehicle 10 and the object 15. Since the origin can be chosen at will, the origin O may be representative of a point on the vehicle 10. This distance D may then be used by the system 12 to determine whether a collision with the vehicle 10 is imminent or whether a collision has occurred in some examples. The slope of the plot of distance D versus time may conform a prediction of a collision approaching in some examples. In some examples, the system 12 may be programmed to initiate a response to a collision condition. In some examples, the response may be one or more of an alert to the driver, an alert to a third party, actuation of a braking system of the vehicle 10, actuation of a steering system of vehicle 10, pre-tensioning seat belts to remove slack, preparing to deploy a hood in case of a collision with a pedestrian, or other responses to alert that a collision has occurred or may occur or prevent a collision from occurring.

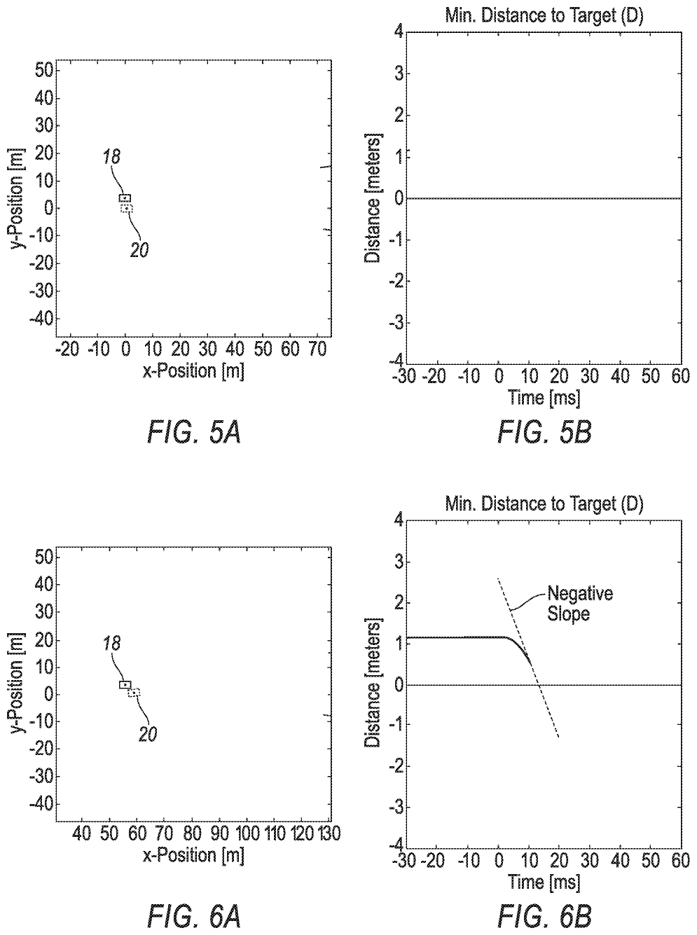

In some examples, as shown in FIGS. 5A-8B, with continued reference to FIGS. 1-4, the controller 16 tracks the distance between the convex hull and the origin against time.

FIG. 5A illustrates the relative positions of the representative polygons 18, 20 at a point in time. FIG. 5B illustrates the distance D between the convex hull 22 of the polygons 18, 20 and the origin O at the point in time shown in FIG. 5A. As the distance D is positive, there is no collision occurring at the positions depicted in FIG. 5A.

FIG. 6A illustrates the relative positions of the representative polygons 18, 20 at a later point in time than in FIG. 5A and representative of a lane change performed by the polygon 20. FIG. 6B illustrates the distance D between the convex hull 22 of the polygons 18, 20 and the origin O at the point in time shown in FIG. 6A. As shown, the distance D is still positive, but is approaching zero, which may indicate that a collision is imminent in some examples. Furthermore, the derivative of the distance D versus time may conform a prediction of a collision approaching. In some examples, a negative slope of distance D versus time indicates a vehicle or other object is approaching, and a positive slope indicates the vehicle or other object is moving away.

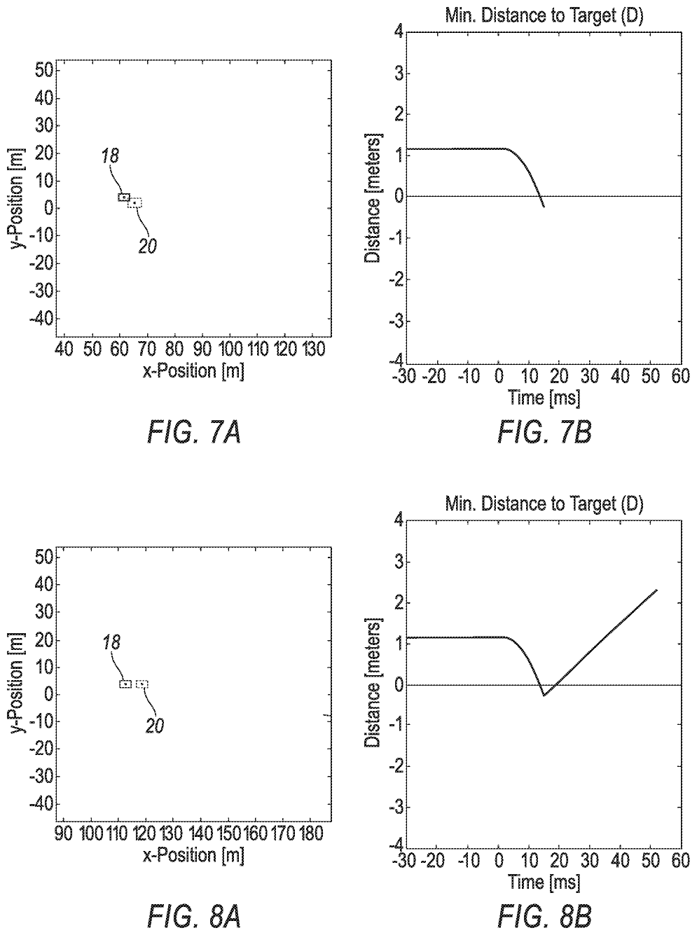

FIG. 7A illustrates the relative positions of the representative polygons 18, 20 at a later point in time than shown in FIG. 6A. FIG. 7B illustrates the distance D between the convex hull 22 of the polygons 18, 20 and the origin O at the point in time shown in FIG. 7A. As shown, the distance D has become negative, which may indicate that a collision has occurred in some examples.

FIG. 8A illustrates the relative positions of the representative polygons 18, 20 at a later point in time than shown in FIG. 7A. FIG. 8B illustrates the distance D between the convex hull of the polygons 18, 20 and the origin O at the point in time shown in FIG. 8A. As shown, the distance D has become positive again, which may indicate that the vehicle 10 and the object 15 are spaced apart again in some examples.

With reference to FIGS. 5B, 6B, 7B, and 8B, the controller 16 plots the distance D between the convex hull 22 and the origin O against time. The controller 16 may be programmed to monitor this distance D to determine whether a collision is imminent or has occurred. In some examples, a collision has occurred when the distance D is zero or negative. In some examples, a collision may be imminent when the distance D is less than a threshold amount. In some examples, additionally or alternatively to the distance D value, a collision may be imminent based on the slope of the plot of the distance against time being below a threshold value. For example, as shown in FIG. 6B the distance D is less than 1 meter and the slope of the plot is negative, which may indicate that a collision is imminent.

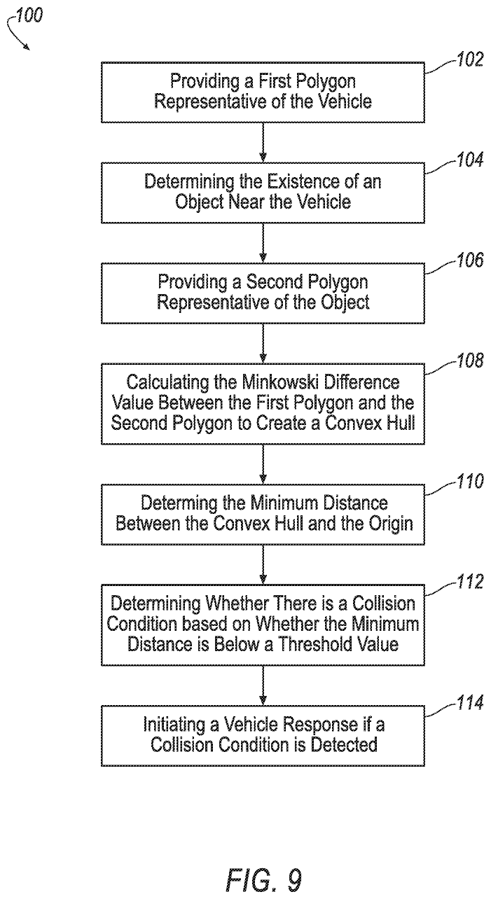

FIG. 9 schematically illustrates a method 100 for evaluating a collision condition for a vehicle, which may be performed with any of the systems 12 disclosed in some examples.

At 102, the method 100 includes providing a first polygon representative of the vehicle.

At 104, the method 100 includes determining the existence of an object near the vehicle. In some examples, this step may include sensing the object with a sensor system on the vehicle.

At 106, the method 100 includes providing a second polygon representative of the object.

At 108, the method 100 includes calculating the Minkowski Difference value between the first polygon and the second polygon to create a convex hull.

At 110, the method 100 includes determining the minimum distance between the convex hull and the origin.

At 112, the method 100 includes determining whether there is a collision condition based on whether the minimum distance is below a threshold value.

At 114, the method 100 includes initiating a vehicle response if a collision condition is detected.

In some examples, the method 100 may include determining whether there is a collision condition based on whether the slope of a plot of the Minkowski Difference value against time is below a threshold value. In some examples, one or more of the steps of the method 100 are performed by the controller 16, with reference to FIG. 1.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method for evaluating a collision condition for a vehicle, the method comprising:
providing a first polygon representative of the vehicle;
determining the existence of an object near the vehicle;
providing a second polygon representative of the object;
calculating the Minkowski Difference between the first polygon and the second polygon to create a convex hull;
determining the minimum distance between the convex hull and an origin of a coordinate system in which the first polygon and the second polygon are overlayed;
determining whether there is a collision condition based on whether the minimum distance is below a threshold value; and
initiating a vehicle response if a collision condition is detected.

2. The method as recited in claim 1, wherein the first polygon is a rectangle.

3. The method as recited in claim 1, wherein the object is a second vehicle near the vehicle.

4. The method as recited in claim 1, wherein the determining step includes sensing the object with a sensor on the vehicle.

5. The method as recited in claim 4, wherein the sensor is a camera.

6. The method as recited in claim 4, wherein the sensor is a radar sensor.

7. The method as recited in claim 1, wherein the first polygon and the second polygon are convex polygons.

8. The method as recited in claim 1, comprising:
determining whether there is a collision condition based on whether the slope of a plot of the Minkowski Difference value against time is below a threshold value.

9. The method as recited in claim 1, wherein the vehicle response is to alert a driver of the vehicle.

10. The method as recited in claim 1, wherein the vehicle response is to activate a braking system of the vehicle.

11. A system for evaluating a collision condition for a vehicle, the method comprising:
a sensor for sensing the existence of an object near the vehicle; and
a controller configured to calculate the Minkowski Difference between a first polygon representative of the vehicle and a second polygon representative of the object to create a convex hull, to determine whether there is a collision condition based on whether the minimum distance from an origin of a coordinate system in which the first polygon and the second polygon are overlayed to the convex hull is below a threshold value, and to initiate a response if a collision condition is determined.

12. The system as recited in claim 11, wherein the sensor is a camera.

13. The system as recited in claim 11, wherein the sensor is a radar sensor.

14. The system as recited in claim 11, wherein the first polygon is a rectangle.

15. The system as recited in claim 11, wherein the object is a second vehicle near the vehicle.

16. The system as recited in claim 11, wherein the first polygon and the second polygon are convex polygons.

17. The system as recited in claim 11, wherein the controller is an electronic control unit on the vehicle.
